(19) United States
(12) Patent Application Publication
(10) Pub. No.: US 2011/0037368 A1
(43) Pub. Date: Feb. 17, 2011

(54) LAMP STRUCTURE

(75) Inventor: Chiang Cheng Huang, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: RISUN EXPANSE CORP., Taipei (TW)

(21) Appl. No.: 12/853,852

(22) Filed: Aug. 10, 2010

(30) Foreign Application Priority Data
Aug. 14, 2009 (TW) 098215056

(51) Int. Cl. H01J 61/52

(52) U.S. Cl. 313/46

(57) ABSTRACT

A lamp structure includes a lamp housing. A plurality of air intake holes is respectively opened on two opposite sides of the lamp housing, and a plurality of vent holes is opened between the plurality of air intake holes on the two sides. A heat sink and a light-emitting element disposed on the heat sink are disposed inside the lamp housing. The heat sink is surrounded by a plurality of heat dissipation fins to form an accommodation chamber for accommodating a fan. When activated, the fan intakes an airflow respectively through the plurality of air intake holes on two sides of the lamp housing, blows the airflow to the plurality of heat dissipation fins, and ventilates the hot air through the vent holes, thereby realizing a double circulatory heat convection exchange effect.

### CROSS-REFERENCE TO RELATED APPLICATIONS

This non-provisional application claims priority under 35 U.S.C. § 119(a) on Patent Application No(s). 098215056 filed in Taiwan, R.O.C. on Aug. 14, 2009, the entire contents of which are hereby incorporated by reference.

### BACKGROUND OF THE INVENTION

1. Field of Invention

The present invention relates to a lamp structure, and more particularly to a lamp structure having double circulatory convection heat dissipation.

2. Related Art

A light emitting diode (LED) has advantages such as power saving, small weight, long lifespan, a low driving voltage, a fast response speed, good vibration resistance. Along with the progress of the fabrication techniques of the LED, the LED also develops towards high brightness, multicolor, and high light emission efficiency. As unit brightness of the LED increases ceaselessly, together with a feature of the LED that more than 80% power is saved, the application field of the LED becomes wider and wider, such as a small indicator on electronic equipment, an illumination system or an outdoor large board, the LED gradually replaces conventional incandescent bulbs or halogen bulbs.

Currently, the brightness of the LED increases ceaselessly, such that the LED may be used as a light source for indoor illumination. Especially, the LED has the advantages of being light, thin, short, and small, so the design of the lamp structure using the LED for indoor illumination becomes more simple and convenient, and the lifespan of the illumination lamp is extended and the power consumption for illumination is greatly saved through the features of the LED.

The application of the LED in the illumination lamps has great advantages, but still some technique bottlenecks need to be overcome. Especially, the temperature factor of the LED is the critical technique that needs to be overcome first when the LED is applied for illumination. For the LED, the luminous intensity is substantially in direct proportion to the driving current, but the use life cycle and reliability of the LED mainly depends on the temperature.

As the heat amount generated by the unit area of the LED is large, after long time of use, the generated heat energy is accumulated and cannot be dissipated, which causes that the temperature of the LED rises with time, and also the ambient temperature rises, so that the overall light emission efficiency of the LED is reduced. Therefore, the temperature is a major factor that determines the light emission efficiency and lifespan of the LED and is also the major barrier for the application of the LED in the illumination lamps. Additionally, currently most illumination lamps are made of light weight material, so the trend of the thin design results in smaller space inside the illumination lamp, which causes that the heat energy emitted by the LED is easily accumulated inside the small space inside the illumination lamp and the heat energy cannot be guided to the outside environment, thus greatly reducing the efficiency of the LED and shortening the lifespan of elements of the LED, and relatively shortening an overall use life of the illumination lamp.

For example, when the LED is powered on, most of the electric energy is converted into light energy to be emitted, and the rest is converted into heat energy to be diffused. If the LED module is sealed inside the illumination lamp structure as a whole, as no heat dissipation measures are adopted, the accumulated heat energy of the LED cannot be quickly dissipated, so the use efficiency and life of the LED are easily affected, and even an overheat damage occurs to internal chips, thus further increasing a damage rate of the illumination lamp.

Therefore, in the prior art, a heat dissipation plate and a fan are disposed inside the illumination lamp, so the heat dissipation plate absorbs the heat energy generated by the LED, and the fan produces an airflow to remove the heat energy on the heat dissipation plate. Generally, an axial fan is correspondingly disposed on the heat dissipation plate, and the structure of the heat dissipation plate usually adopts the design of a plurality of radial heat dissipation fins. The axial airflow produced by the axial fan is blown to airflow passages formed between the plurality of heat dissipation fins, thereby removing the heat energy on the heat dissipation fins.

However, in order to increase an illumination brightness condition of the lamp, more LEDs need to be added inside the lamp. Correspondingly, the heat dissipation condition of the LED also needs to be enhanced. For example, a heat dissipation area of the heat dissipation plate needs to be increased, so that more heat dissipation fins are provided on the heat dissipation plate or a rotation speed of the axial fan is increased, so as to increase air quantity and air velocity.

However, more heat dissipation fins may easily result in even smaller airflow passages between the heat dissipation fins and further increase air resistance that the airflow is blown to the airflow passages (that is, turbulence occurs), such that the airflow is blocked and the original smooth airflow passages are affected. If the rotation speed of the axial fan is further increased to increase the flow quantity, a noise impulse (dynamic noise) occurs under the influence of the air resistance, and together with the noise generated by the electronic devices of the lamp during operation, the overall noise level and prominence ratio of the lamp are increased.

Therefore, the related manufacturers in the industry urgently need to effectively improve the air convection structure inside the illumination lamp.

### SUMMARY OF THE INVENTION

Therefore, in view of the above problems, the present invention provides a lamp structure, so as to improve a heat dissipation convection effect inside the lamp and eliminate the problem of noise impulse of the lamp in the prior art.

The lamp structure of the present invention comprises a lamp housing, a heat sink, and a fan. A plurality of first air intake holes and a plurality of second air intake holes are respectively opened on two opposite sides of the lamp housing, and a plurality of vent holes is opened between the first air intake holes and the second air intake holes. The heat sink is accommodated inside the lamp housing, at least a light-emitting element is disposed on the heat sink, and a plurality of heat dissipation fins surround the heat sink from outside, such that the heat dissipation fins correspond to the plurality of vent holes, and the heat dissipation fins surround to form an accommodation chamber. The fan is disposed inside the accommodation chamber, which guides an airflow to enter the lamp housing respectively through the plurality of first air intake holes and the plurality of second air intake holes and blows the airflow to the plurality of heat dissipation fins, and the hot air is then ventilated through the plurality of vent holes.

The effect of the present invention is as follows. The light-emitting element (LED) is attached to the heat sink of the lamp housing, so as to take advantage of the characteristics of the LED such as no idling time, quick response, a small size, low power consumption, low pollution, high brightness, and long lifespan. The airflow is taken in through the air intake holes on two opposite sides of the lamp housing by using the fan, and guided to be blown to the heat dissipation fins for heat dissipation, and ventilated through the vent holes after dissipation. Thus, double circulatory heat exchange convection is realized, thus effectively improving the heat dissipation efficiency and extending the overall use life of the LED.

The aforementioned fan may be a blower fan. Through a structure design in which the blower fan is surrounded by a plurality of heat dissipation fins, the side airflow generated by the blower fan may smoothly and evenly pass through the airflow passages between the plurality of heat dissipation fins without air resistance, so that the noise of the blower fan is decreased due to the uniform flow field without turbulence.

In this manner, the lamp may be applied in the socket of a conventional lamp holder to form electrical connection, and the holder may be designed to the work voltage suitable for the LED according to the use characteristics, so that the conventional tungsten filament bulb can be completely replaced, thus achieving functions of light source irradiation, identification, decoration or indication.

### BRIEF DESCRIPTION OF THE DRAWINGS

The present invention will become more fully understood from the detailed description given herein below for illustration only, and thus are not limitative of the present invention, and wherein:

FIG. 1 is a schematic exploded view according to a first embodiment of the present invention;

FIG. 2 is a schematic partial combination view according to the first embodiment of the present invention;

FIG. 3 is a schematic sectional view according to the first embodiment of the present invention;

FIG. 4 is a schematic partial combination view according to a second embodiment of the present invention;

FIG. 5 is a schematic sectional view according to the second embodiment of the present invention;

FIG. 6 is a schematic partial combination view according to a third embodiment of the present invention;

FIG. 7 is a schematic partial combination view according to a fourth embodiment of the present invention; and

FIG. 8 is a schematic sectional view according to a fifth embodiment of the present invention.

### DETAILED DESCRIPTION OF THE INVENTION

In order to make the objectives, structures, characteristics, and functions of the present invention more comprehensive, the embodiments are illustrated in detail as follows.

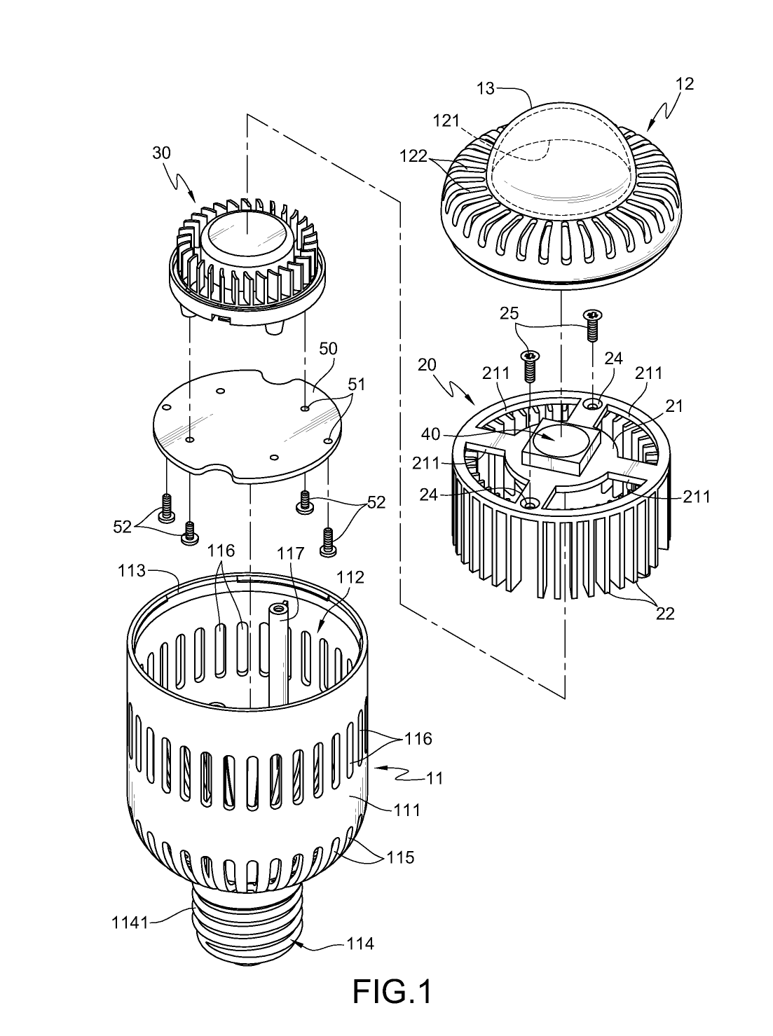

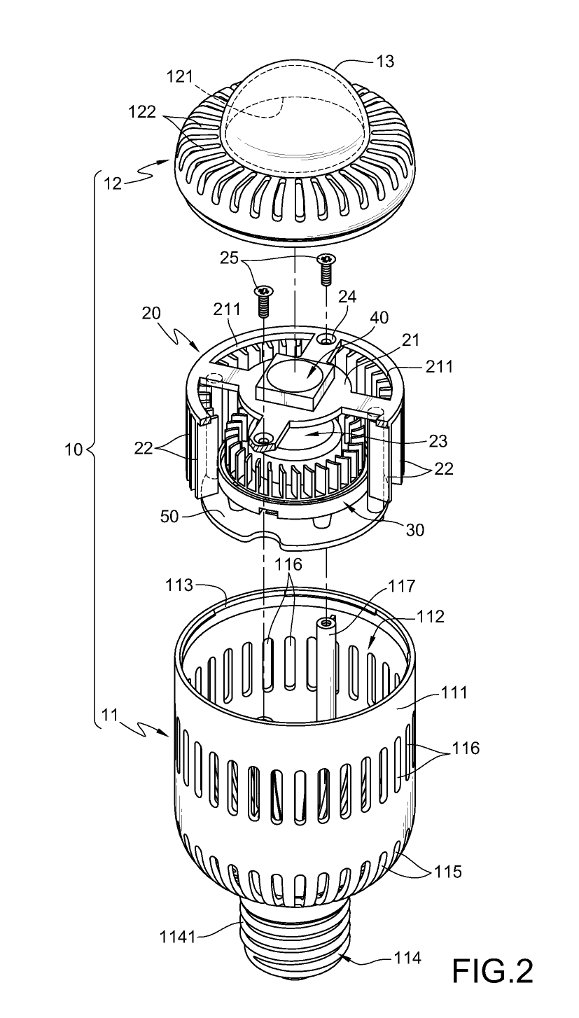

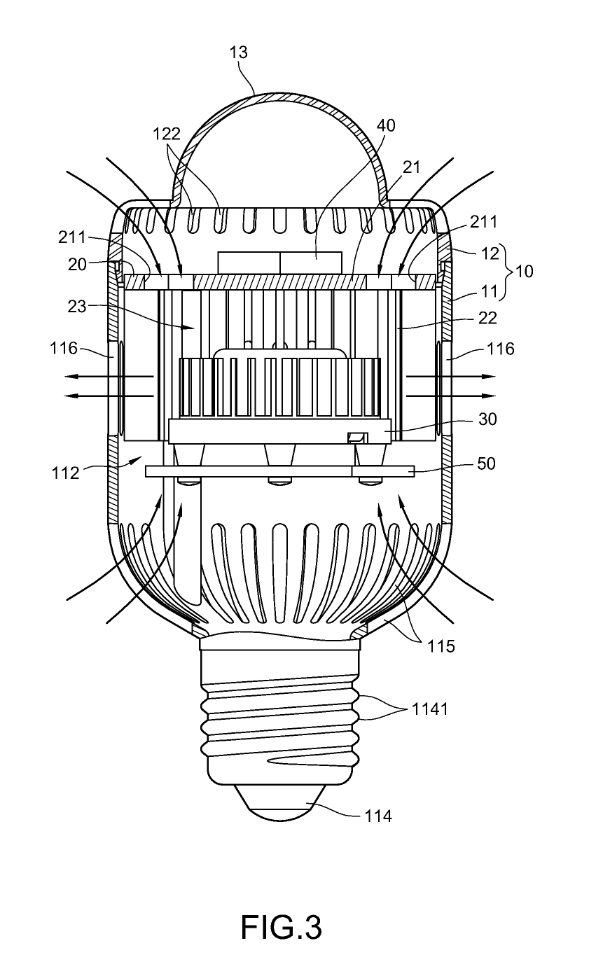

As shown in FIGS. 1, 2, and 3, FIG. 1 is a schematic exploded view according to a first embodiment of the present invention. FIG. 2 is a schematic partial combination view according to the first embodiment of the present invention. FIG. 3 is a schematic sectional view according to the first embodiment of the present invention.

The lamp structure of the present invention substantially comprises a lamp housing 10, a heat sink 20, and a fan 30. The lamp housing 10 has a body 11 and a cover 12. The body 11 has a surrounding wall 111 that surrounds along a vertical axis, and a chamber 112 is defined inside the surrounding wall 111. An opening 113 is formed on one side of the body 11, and an electrically conductive portion 114 is disposed on the other side of the body 11.

The electrically conductive portion 114 has a male thread 1141 disposed on the surface thereof, and the electrically conductive portion 114 has a specification that comply with that of a metal screw adapter of a conventional tungsten filament bulb, which includes different specifications such as E10, E12, E14, E26, E27, and E40. Here, the number following the letter E indicates a diameter of the electrically conductive portion 114 (for example, a household bulb is usually E27, that is to say, a diameter of the male thread 1141 of the electrically conductive portion 114 of the lamp is 27 mm=2.7 cm). For the electrically conductive portion 114 in the present invention, the specification E27 is used as a preferred embodiment for illustration, but the specification is not limited thereto. The electrically conductive portion 114 is applied in the insertion opening (not shown) of the conventional lamp holder, such that the lamp housing 10 is locked in the insertion opening of the conventional lamp holder by the design of the male thread 1141 of the electrically conductive portion 114. The lamp structure of the present invention may be applicable to different power sources such as AC 12V, DC 12V, AC 110V, and AC 220V.

Furthermore, the body 11 further has a plurality of first air intake holes 115 and a plurality of vent holes 116. The plurality of first air intake holes 115 is formed on an end surface of the body 11 and adjacent to the electrically conductive portion 114, and the plurality of vent holes 116 is formed on the surface of the body 11 at a position away from the electrically conductive portion 114. The optimal positions of the plurality of vent holes 116 are preferably at the center of the surface of the body 11, but the present invention is not limited thereto.

Then, the cover 12 is combined on the body 11 and shields the opening 113 of the body 11. The cover 12 further has a light hole 121 and a plurality of second air intake holes 122. The light hole 121 is formed on the surface of the cover 12 and provides a lens 13 that is combined on the light hole 121. The plurality of second air intake holes 122 is formed surrounding the light hole 121.

The heat sink 20 is accommodated inside the lamp housing 10. The heat sink 20 has a heat conductive portion 21, at least a light-emitting element 40 is attached to the heat conductive portion 21, and a plurality of apertures 211 is formed on the heat conductive portion 21. Additionally, a plurality of heat dissipation fins 22 surrounds the heat sink 20 from outside, and the heat dissipation fins 22 are vertically arranged at an interval, such that the heat dissipation fins 22 surround to form an accommodation chamber 23.

The fan 30 is accommodated in the accommodation chamber 23 of the heat sink 20. The fan 30 is a blower fan, and a circuit board 50 is disposed at the bottom of the fan 30. An electronic component (no shown) is disposed on at least one side of the circuit board 50, and a plurality of first locking holes 51 is formed on the circuit board 50. A plurality of first locking member 52 penetrates the corresponding first locking holes 51, and is then locked on the heat sink 20 and the fan 30. Thus, the heat sink 20 and the fan 30 are assembled on the circuit board 50.

Next, the heat sink 20 may be assembled inside the body 11 of the lamp housing 10, and at least a locking portion 117 is disposed on the surrounding wall 111 of the body 11. The heat sink 20 has at least a second locking hole 24 at the position corresponding to the locking portion 117. At least a second locking member 25 penetrates the corresponding second locking hole 24, and is then locked inside the locking portion 117 of the body 11, such that the heat sink 20 and the fan 30 are assembled inside the chamber 112 of the body 11. Subsequently, the cover 12 is combined on the body 11 and covers the opening 113, such that the light-emitting element 40 emits a light ray towards the lens 13 of the cover 12.

When the fan 30 is activated, the fan 30 takes in the airflow respectively through the plurality of first air intake holes 115 and the plurality of second air intake holes 122 of the lamp housing 10 and blows the airflow to the plurality of heat dissipation fins 22 of the heat sink 20. Next, after removing the heat of the plurality of heat dissipation fins 22, the airflow may be ventilated through the plurality of vent holes 116 of the lamp housing 10, thereby producing a double circulatory convection effect, so as to quickly remove the heat generated by the light-emitting element 40, thus preventing the light-emitting element 40 from being affected by the ambient temperature inside the lamp housing 10, so as to effectively improve the heat dissipation efficiency and improve the light emission efficiency and overall use life of the light-emitting element 40.

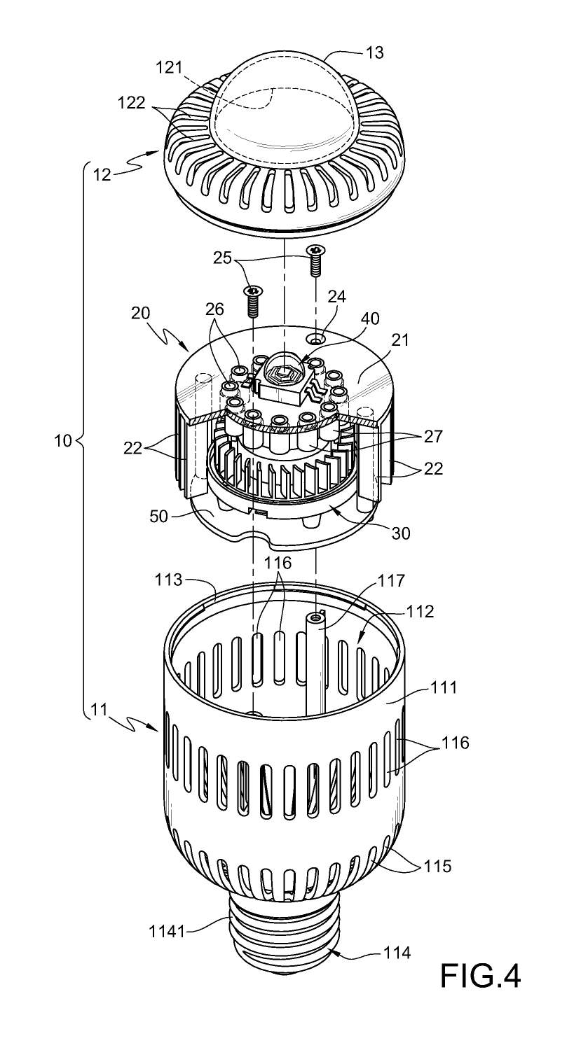

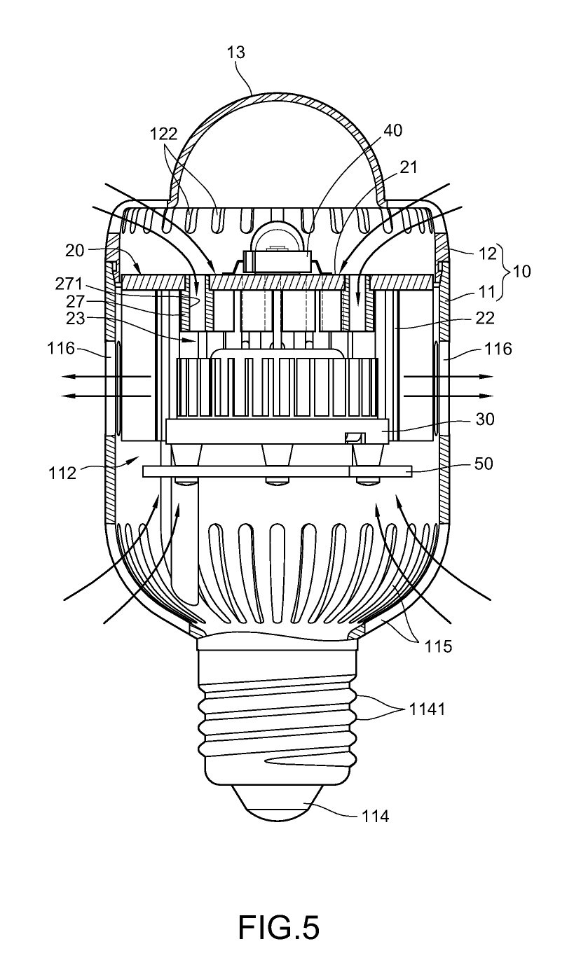

FIGS. 4 and 5 are a schematic partial combination view and a schematic sectional view according to the second embodiment of the present invention. The embodiments are substantially the same as the first embodiment, and only the differences are illustrated below. The heat sink 20 further comprises a plurality of perforations 26, the perforations 26 are formed on the heat conductive portion 21, and a plurality of air ducts 27 is disposed at the bottoms of the plurality of perforations 26 correspondingly. When the airflow is taken in from the plurality of second air intake holes 122, the airflow enters respectively from one side of the air ducts 27 and is ejected from the other side of the air ducts 27, such that the fan 30 may quickly guide the ejected airflow to the heat dissipation fins 22 for heat dissipation.

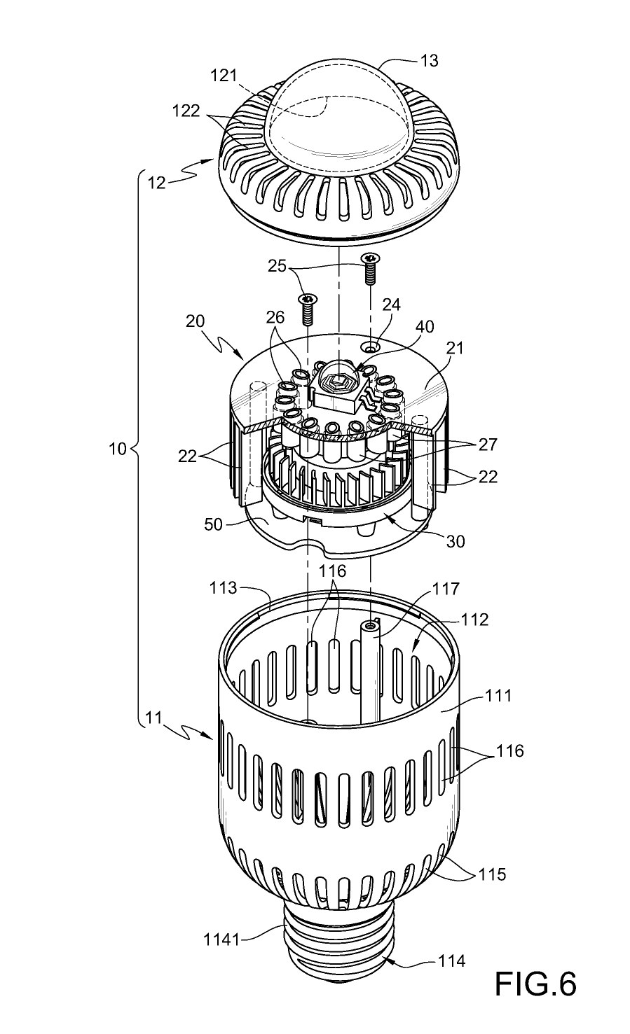

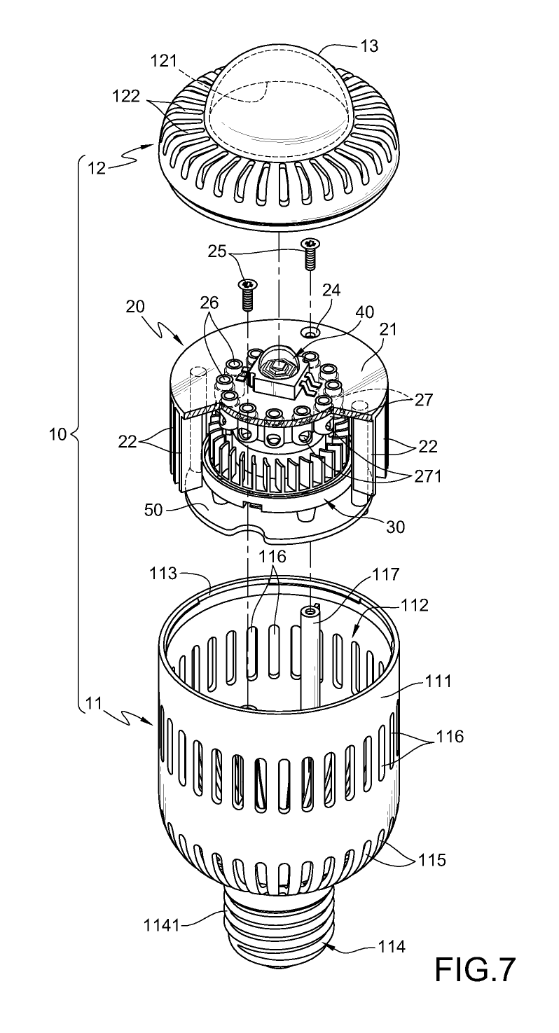

Additionally, the air ducts 27 may be a round column pipe. The air ducts 27 may also be designed into an oval column pipe. FIG. 6 is a schematic partial combination view according to the third embodiment of the present invention. The section of the air ducts 27 is designed to be an oval shape, so as to acquire a large air intake quantity. However, the present invention is not limited thereto. According to the use requirements, the section of the air ducts 27 may also be designed to be round, oval, triangular, quadrilateral or polygonal. Further, a through hole 271 is formed on one side of the air ducts 27. FIG. 7 is a schematic partial combination view according to a fourth embodiment of the present invention. The through holes 271 are facing the heat dissipation fins 22, such that when the airflow enters the air ducts 27, a part of the airflow may be ventilated to the upper half portion of the heat dissipation fins 22 through the through holes 271 and the other part of the airflow is guided by the fan 30 to the lower half portion of the heat dissipation fins 22, thereby uniformly blowing cold air to the heat dissipation fins 22.

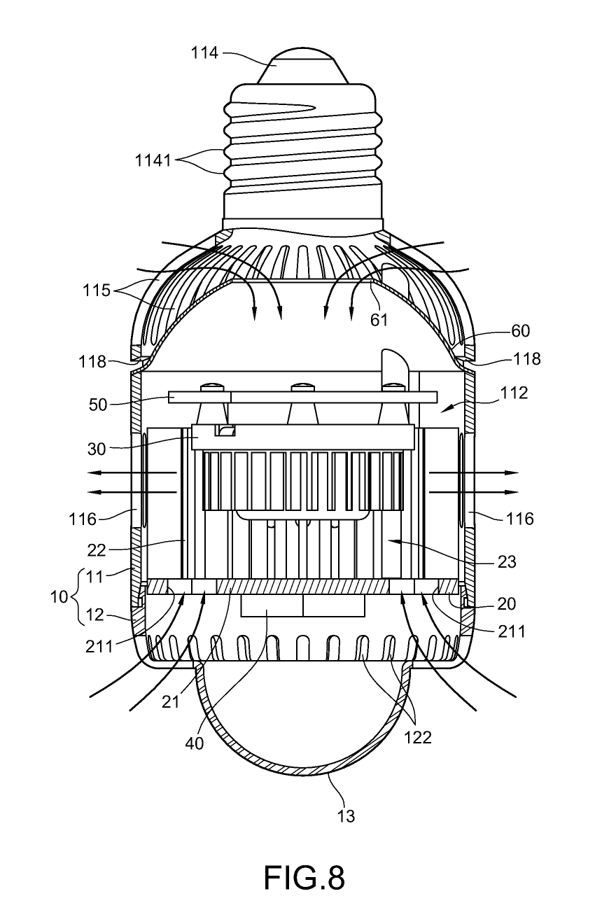

FIG. 8 is a schematic sectional view according to a fifth embodiment of the present invention. The embodiment is substantially the same as the first embodiment, and only the differences are illustrated hereinafter. A drainage hole 118 is formed near the side of the plurality of first air intake holes 115, and a waterproof hood 60 is disposed inside the chamber 112 of the body 11 and corresponds to the plurality of first air intake holes 115. At least a hole 61 is formed on the top surface of the waterproof hood 60. If rain water enters the body 11 of the lamp housing 10 from the plurality of first air intake holes 115, the rain water falls into the drainage hole 118 from the side of the waterproof hood 60 and is then drained through the design of rounded top surface of the waterproof hood 60. The airflow enters the heat sink 20 from the hole 61 of the waterproof hood 60 for heat dissipation.

What is claimed is:

1. A lamp structure, comprising:
a lamp housing, having a plurality of first air intake holes and a plurality of second air intake holes respectively formed on two opposite sides of the lamp housing, and a plurality of vent holes formed between the first air intake holes and the second air intake holes;
a heat sink, accommodated inside the lamp housing, having at least a light-emitting element disposed on the heat sink and a plurality of heat dissipation fins surrounding the heat sink from outside, wherein the heat dissipation fins correspond to the vent holes, and the heat dissipation fins surround to form an accommodation chamber; and
a fan, disposed inside the accommodation chamber, and guiding an airflow to enter the lamp housing respectively through the first air intake holes and the second air intake holes, and blowing the airflow to the heat dissipation fins so the airflow is ventilated from the vent holes, such that double circulatory heat exchange convection is formed inside the lamp housing.

2. The lamp structure according to claim 1, wherein the lamp housing further comprises a body and a cover, the first air intake holes and the vent holes are formed on a surface of the body and the second air intake holes are formed on a surface of the cover.

3. The lamp structure according to claim 2, wherein the body further has an electrically conductive portion having a male thread disposed on a surface thereof.

4. The lamp structure according to claim 2, wherein the cover further has a light hole, and the second air intake holes are disposed surrounding the light hole.

5. The lamp structure according to claim 4, further comprising a lens disposed on the light hole.

6. The lamp structure according to claim 1, wherein the heat sink further has a heat conductive portion, the light-emitting element is attached to the heat conductive portion, and the heat dissipation fins surround the heat conductive portion from outside.

7. The lamp structure according to claim 6, wherein the heat conductive portion is formed with a plurality of apertures.

8. The lamp structure according to claim 6, wherein the heat conductive portion is opened with a plurality of perforations, a plurality of air ducts is disposed at bottoms of the perforations correspondingly, and the air ducts are accommodated inside the accommodation chamber.

9. The lamp structure according to claim 8, wherein a through hole is opened on a surface of each air duct respectively, and the through holes respectively face the heat dissipation fins.

10. The lamp structure according to claim 1, further comprising a circuit board, wherein the heat sink and the fan are locked on the circuit board.

11. The lamp structure according to claim 1, further comprising a waterproof hood disposed inside the lamp housing and corresponding to the first air intake holes.
